(19) United States
(12) Patent Application Publication
(10) Pub. No.: US 2006/0202663 A1
(43) Pub. Date: Sep. 14, 2006

(54) Method of setting initial value of SOC of battery using OCV hysteresis depending on temperatures

(76) Inventors: Il Cho, Daejeon (KR); Do Youn Kim, Daejeon (KR)

Correspondence Address: CANTOR COLBURN, LLP, 55 GRIFFIN ROAD SOUTH, BLOOMFIELD, CT, 06002, US

(21) Appl. No.: 11/370,403

(22) Filed: Mar. 8, 2006

(30) Foreign Application Priority Data
Mar. 9, 2005 (JP) 10-2005-0019487

(51) Int. Cl. H02J 7/00

(52) U.S. Cl. 320/132

(57) ABSTRACT

Disclosed is a method of setting an initial value of a SOC of a battery more accurately in consideration of an open circuit voltage (OCV) variation depending on temperatures and aging. The method comprises steps of experimentally measuring open circuit voltage (OCV) values under various temperatures; structuring a table correlating the measured OCV values and SOC values of the battery classified by on the temperatures; storing the table in a battery management system (BMS); measuring current temperature and OCV value with the BMS; obtaining a SOC value of the battery corresponding to the measured values by referring to the table; and setting the obtained value as an initial SOC value of the battery.

This application claims the benefit of Korean Patent Application No. 10-2005-0019487, filed on Mar. 9, 2005 in Korea Industrial Property Office, which is hereby incorporated by reference in its entirety for all purposes as if fully set forth herein.

### BACKGROUND OF THE INVENTION

1. Field of the Invention

The invention relates to a method of setting an initial value of a residual capacity (SOC; State of Charge) of a battery, and more particularly to a method of setting an initial value of a SOC of a battery more accurately in consideration of an open circuit voltage (OCV) variation depending on temperatures and aging.

2. Description of the Prior Art

An electric vehicle uses electric energy stored in a battery as an energy source. A lithium-ion polymer battery is much used as the battery for the electric vehicle, and a research thereof has been also actively carried out.

In the mean time, since a gasoline vehicle drives an engine using the fuel, it is not difficult to measure an amount of the fuel. However, in case of the electric vehicle, it is difficult to measure residual energy accumulated in the battery. In the mean time, it is very important for a driver of the electric vehicle to know the information about how much the energy remains and to what extent the driver can drive.

In other words, since the electric vehicle is driven with the energy stored in the battery, it is very important to perceive the residual capacity of the battery. Accordingly, many technologies have been developed which measure the SOC of the battery during the traveling to notify the operator of the information about the possible distance covered.

In addition, many attempts have been performed which properly set an initial value of the SOC of the battery before the traveling. At this time, the initial value of the SOC is set with reference to an open circuit voltage (OCV). In this method, the initial value is set on condition that the OCV is not changed depending on the environments and is an absolute reference value of the SOC.

However, according to many tests and theses, the OCV is changed depending on the temperatures and the aging, instead of having a fixed value irrespective of the environments. However, according to the conventional methods of setting an initial value of the SOC of the battery, it is not considered that the OCV is changed depending on the temperatures. Accordingly, the conventional methods cannot accurately estimate the SOC of the battery.

### SUMMARY OF THE INVENTION

Accordingly, the invention has been made to solve the above problems.

An object of the invention is to provide a method of setting an initial value of a SOC of a battery more accurately in consideration of an open circuit voltage (OCV) hysteresis depending on temperatures.

In order to achieve the above object, according to the invention, there is provided a method of setting an initial value of a SOC of a battery comprising steps of: experimentally measuring open circuit voltage (OCV) values under various temperatures; structuring a table correlating the measured OCV values and SOC values of the battery classified by the temperatures; storing the table in a battery management system (BMS); measuring current temperature and OCV value with the BMS; obtaining a SOC value of the battery corresponding to the measured values by referring to the table; and setting the obtained value as an initial SOC value of the battery.

According to a preferred embodiment of the invention, the method may further comprise a step of re-setting the SOC of the battery using the OCV values depending on the various temperatures.

According to an embodiment of the invention, the table may have a horizontal axis in which the temperatures are divided in a unit of 5° C. between −30° C. and +45° C. and a vertical axis in which the SOC is divided in a unit of 1% between 0 and 100%.

### BRIEF DESCRIPTION OF THE DRAWINGS

The above and other objects, features and advantages of the present invention will be more apparent from the following detailed description taken in conjunction with the accompanying drawings, in which:

FIG. 1 is a flow chart showing a process of carrying out a method according to an embodiment of the invention.

### DETAILED DESCRIPTION OF THE PREFERRED EMBODIMENTS

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

As described above, an open circuit voltage (OCV) which is referred to set an initial value of a SOC of a battery is changed depending on temperatures and aging, instead of having a fixed value irrespective of the environments. Contrary to the prior art of setting the initial value of the SOC on the assumption that the OCV has a fixed value, according to the present invention, an OCV hysteresis, which is changed depending on the temperatures, is considered and used to set the initial value of the SOC, so that it is possible to reduce a general error of an algorithm for estimating the SOC.

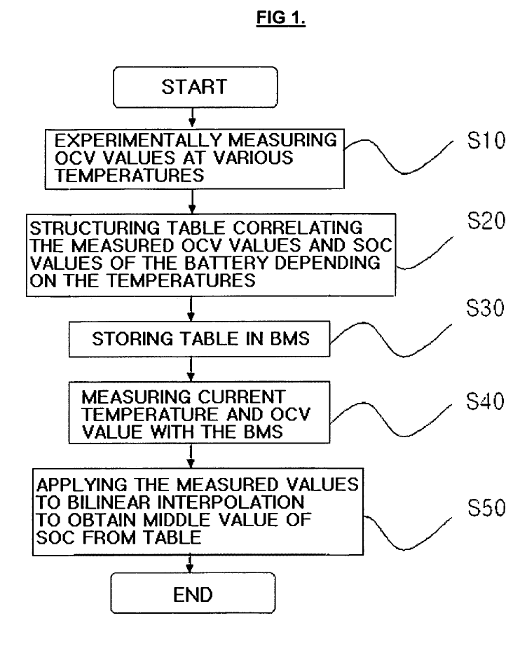

In the followings, it is more specifically described a method according to an embodiment of the invention, with reference to FIG. 1. First, the OCV values are experimentally measured under various temperatures in which the battery is operated (S10), contrary to the prior art.

For example, instead of obtaining only a relationship between the SOC and the OCV which is a reference value of the SOC, the OCV values are experimentally measured in advance under various temperatures in which the battery is actually mounted and operated and then it is structured a table correlating the OCV values and the SOC depending on the temperatures (S20).

According to an embodiment of the invention, the table has a horizontal axis in which the temperatures are divided in a unit of 5° C. between −30° C. and +45° C. in consideration of the actual operating temperatures of the battery and a vertical axis in which the SOC is divided in a unit of 1% between 0 and 100%. An example of the table is shown as follows.

TABLE 1
OCV and SOC depending on the temperatures

| | temperature (° C.) | | | | |
|---|---|---|---|---|---|
| SOC | −30 | . . . | 25 | 30 | . . . |
| 0.01 (1%) | 2.845 | . . . | 2.90 | 2.95 | . . . |
| 0.02 (2%) | 2.855 | . . . | 2.92 | 2.96 | . . . |
| . | . | . | . | . | . |
| . | . | . | . | . | . |
| . | . | . | . | . | . |

Next, the above table is stored in a battery management system (BMS) (S30) and then current temperature and OCV value are measured in the BMS (S40).

In the mean time, in general, the current temperature and OCV value which are measured at real time in the BMS do not accurately correspond to the temperature and the OCV in the table, but belong to between the values before and after the measured value. Accordingly, in order to find out a SOC value corresponding to the current temperature and OCV measured with reference to the table, the most approximate 2 values are read out from the table and then applied to a bilinear interpolation to approximate a middle value (S50). For example, when the BMS measures the current temperature 27° C. and the OCV 2.93, the corresponding SOC is between 0.01 (1%) and 0.02 (2%) in the table 1. Accordingly, a middle value of the SOC is found out by applying a universal bilinear interpolation and the found SOC value is set as an initial SOC value of the battery (S50).

The initial SOC value estimated and set through the procedures is transmitted to a vehicle control device of the hybrid electric vehicle via the BMS to control the charge/discharge output of the battery.

Like this, according to the invention, contrary to the prior art of setting an initial SOC value with reference to the fixed OCV, it is structured a table in which the OCV values which are changed depending on the temperatures are previously correlated with the SOC values depending on the temperatures. Then, the OCV is measured at a temperature at which it is desired to set the initial SOC value and an approximate SOC value corresponding to the measured OCV is found out from the table and set as the initial value. Accordingly, it is possible to estimate the initial SOC value depending on the temperatures.

In the mean time, according to a preferred embodiment of the invention, the method may further comprise a step of re-setting the SOC of the battery using the OCV values depending on the various temperatures, so that it is possible to carry out a setting of an initial SOC value at each of the temperatures, as necessary.

As described above, according to the invention, it is set the initial value of the SOC in consideration that the open circuit voltage is changed depending on the temperatures. Accordingly, it is possible to correct the error resulting from no consideration of the OCV change depending on the temperatures, so that the initial value of the SOC can be more accurately set.

While the invention has been shown and described with reference to certain preferred embodiments thereof, it will be understood by those skilled in the art that various changes in form and details may be made therein without departing from the spirit and scope of the invention as defined by the appended claims.

1. A method of setting an initial value of a SOC of a battery comprising steps of:
experimentally measuring open circuit voltage (OCV) values under various temperatures;
structuring a table correlating the measured OCV values and SOC values of the battery classified by the temperatures;
storing the table in a battery management system (BMS);
measuring current temperature and OCV value with the BMS;
obtaining a SOC value of the battery corresponding to the measured values by referring to the table; and
setting the obtained value as an initial SOC value of the battery.

2. The method according to claim 1, further comprising a step of resetting the SOC of the battery using the OCV values according to the various temperatures.

3. The method according to claim 1, wherein the table has a horizontal axis in which the temperatures are divided in a unit of 5° C. between −30° C. and +45° C. and a vertical axis in which the SOC is divided in a unit of 1% between 0 and 100%.

4. The method according to claim 2, wherein the table has a horizontal axis in which the temperatures are divided in a unit of 5° C. between −30° C. and +45° C. and a vertical axis in which the SOC is divided in a unit of 1% between 0 and 100%.

5. The method according to claim 1, further comprising a step of resetting approximating the obtained value by a bilinear interpolation.

6. The method according to claim 2, wherein the table has a horizontal axis in which the temperatures are divided in a unit of 5° C. between −30° C. and +45° C. and a vertical axis in which the SOC is divided in a unit of 1% between 0 and 100%.
